(19) United States
(12) Patent Application Publication
(10) Pub. No.: US 2025/0028528 A1
(43) Pub. Date: Jan. 23, 2025

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventor: Osamu DAIDO, Tokyo (JP)

(73) Assignee: NEC Corporation, Tokyo (JP)

(21) Appl. No.: 18/758,582

(22) Filed: Jun. 28, 2024

(30) Foreign Application Priority Data
Jul. 21, 2023 (JP) 2023-119238

(51) Int. Cl. G06F 8/75; G06F 8/30

(52) U.S. Cl. CPC G06F 8/75; G06F 8/315

(57) ABSTRACT

An information processing apparatus includes: a detection unit that detects whether or not a code for reading a module includes a description regarding a first library when interrupt processing for replacing the first library with a second library compatible with the first library occurs, a determination unit that, when a code for reading the first library is detected, refer to hierarchy information indicating a parent-child relationship for reading a first module that includes the code for reading the first library, and determine whether or not the first library or the second library is being used by a module at a higher layer than the first module; and a reading unit that reads the second library in place of the first library if the first library or the second library is not being used by a module at a higher layer.

### CROSS-REFERENCE TO RELATED APPLICATION

This application is based upon and claims the benefit of priority from Japanese patent application No. 2023-119238, filed on Jul. 21, 2023, the disclosure of which is incorporated herein in its entirety by reference.

### BACKGROUND OF THE INVENTION

### 1. Field of the Invention

The present disclosure relates to an information processing apparatus, an information processing method, and a computer-readable recording medium.

### 2. Background Art

Pandas is known as a de facto standard library that is used for data analysis, and as a library that is used for data analysis processing and data processing of a programming language Python (registered trademark). In addition, there are known cases where an advanced library that can execute processing at a higher speed than when pandas is used, and is compatible with pandas is used in place of pandas.

The aforementioned advanced library maintains compatibility with pandas using a fallback function. An API (Application Programming Interface) is used to call an implemented function (method) from the advanced library. On the other hand, when a function that is not implemented in the advanced library is called, pandas is used. With such a configuration, virtually there is no function (method) that is not implemented in the advanced library, and thus high compatibility can be realized.

However, when an advanced library is used in place of pandas, there is a need to edit the source codes of a module of a user program, a module of the advanced library, and a module of a library other than the advanced library.

As a related technique, Patent Document 1 (Japanese Patent Laid-Open Publication No. 2010-257103) discloses an information processing apparatus that shortens a time required for program change/recovery, which is temporarily performed on a program such as firmware that is used for debugging or information collection for market research or the like. With the information processing apparatus of Patent Document 1, the source code of a program read out from a ROM (Read Only Memory) and deployed to a RAM (Random Access Memory) is rewritten so as to execute a change module before a target module included in the program is executed.

However, when the source code of the module is edited, trouble such as an error in rewriting of the source code occurs. Therefore, the source code is not desired to be edited whenever possible.

In addition, in the information processing apparatus in Patent Document 1, a replacing module D (change module) is called from a predetermined module B, and only a module C before replacement is called.

### SUMMARY OF THE INVENTION

An example object of the present disclosure is to eliminate the need to rewrite a source code of a module when an advanced library is used.

In order to achieve the example object described above, an information processing apparatus according to an example aspect includes:
a detection unit detects whether or not a code for reading a module includes a description regarding a first library when interrupt processing for replacing the first library with a second library compatible with the first library occurs;
a determination unit, when a code for reading the first library is detected, refer to hierarchy information indicating a parent-child relationship for reading a first module that includes the code for reading the first library, and determine whether or not the first library or the second library is being used by a module at a higher layer than the first module; and
a reading unit reads the second library in place of the first library if the first library or the second library is not being used by a module at a higher layer.

Also, in order to achieve the example object described above, an information processing method that is performed by a information processing apparatus according to an example aspect includes:
detecting whether or not a code for reading a module includes a description regarding a first library when interrupt processing for replacing the first library with a second library compatible with the first library occurs;
when a code for reading the first library is detected, referring to hierarchy information indicating a parent-child relationship for reading a first module that includes the code for reading the first library, and determining whether or not the first library or the second library is being used by a module at a higher layer than the first module; and
reading the second library in place of the first library if the first library or the second library is not being used by a module at a higher layer.

Furthermore, in order to achieve the example object described above, a computer-readable recording medium according to an example aspect includes a program recorded on the computer-readable recording medium, the program including instructions that cause the computer to carry out:
detecting whether or not a code for reading a module includes a description regarding a first library when interrupt processing for replacing the first library with a second library compatible with the first library occurs;
when a code for reading the first library is detected, referring to hierarchy information indicating a parent-child relationship for reading a first module that includes the code for reading the first library, and determining whether or not the first library or the second library is being used by a module at a higher layer than the first module; and
reading the second library in place of the first library if the first library or the second library is not being used by a module at a higher layer.

According to the present disclosure as described above, even when an advanced library is used, it is possible to eliminate the need to rewrite the source code of a module.

### BRIEF DESCRIPTION OF THE DRAWINGS

FIG. 1 is a diagram for describing an exemplary configuration of the information processing apparatus.

FIG. 2 is a diagram for describing an example of a system that includes the information processing apparatus.

FIG. 3 is a diagram for describing an example of a command line for executing interrupt processing.

FIG. 4 is a diagram for describing an example of operations of the determination unit.

FIG. 5 is a diagram for describing an example of operations of generation of an interrupt processing unit.

FIG. 6 is a diagram for describing an example of operations of interrupt processing.

FIG. 7 is a diagram for describing an example of operations of the interrupt processing unit.

FIG. 8 is a diagram for describing an example of a computer that realizes the information processing apparatus in the example embodiment and modified example.

### EXEMPLARY EMBODIMENT

Hereinafter, an example embodiment will be described with reference to the drawings. Note that, in the drawings described below, elements having the same functions or corresponding functions are denoted by the same reference numerals, and repeated description thereof may be omitted.

### Example Embodiment

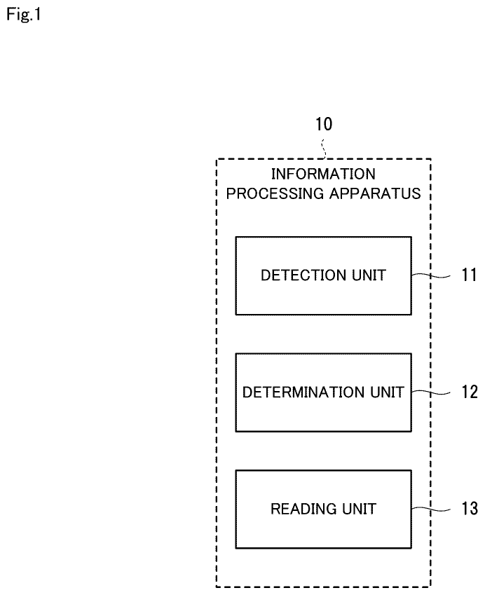

A configuration of an information processing apparatus according to an example embodiment will be described with reference to FIG. 1. FIG. 1 is a diagram for describing an exemplary configuration of an information processing apparatus.

### [Apparatus Configuration]

The information processing apparatus shown in FIG. 1 is an apparatus that can eliminate the need to rewrite the source code of a module even when an advanced library is used. In addition, an information processing apparatus 10 shown in FIG. 1 includes a detection unit 11, a determination unit 12, and a reading unit 13.

When interrupt processing for replacing a first library with a second library that is compatible with the first library occurs, the detection unit 11 detects whether or not a code for reading a module includes a description regarding the first library.

A user program and the first library are created in a program language such as Python. Note that the program language is not limited to Python. In addition, when Python is used, the first library is, for example, pandas that is a library of Python. Note that the first library is not limited to pandas. The second library is a more advanced library than the first library. The “more advanced library” is a library that enables processing to be executed at a higher speed than when the first library is used, for example.

When a code for reading the first library is detected, the determination unit 12 refers to hierarchy information indicating the parent-child relationship for reading a first module that includes the code for reading the first library, and determines whether or not the first library or the second library is being used by a module at a higher layer than the first module.

The hierarchy information is a log indicating a parent-child relationship for reading modules, or the like. The hierarchy information is a list of file paths of modules such as that shown below, for example.

### <List of Files>

/lib/python3/site-packages/pandas/_init_.py
/lib/python3/site-packages/pandas/core/api.py
/lib/python3/site-packages/pandas/core/groupby/_init_.py
/lib/python3/site-packages/pandas/core/groupby/groupby.py
/lib/python3/site-packages/pandas/core/groupby/generic.py
/lib/python3/site-packages/pandas/core/groupby/ops.py
/lib/python3/site-packages/pandas/core/groupby/grouper.py

The above list indicates that the modules are read in descending order. First, “pandas/_init_” indicates that “pandas/core/api.py” is to be read, “pandas/core/api.py” indicates that “pandas/core/groupby/_init_” is to be read, and “pandas/core/groupby/_init_” indicates that “pandas/core/groupby/groupby.py” is to be read.

Note that “_init_” is a file that is read first when an instruction to read the entire folder as a module is given. When an instruction to read a file named pandas is given, for example, Python first detects pandas/_init_”.

When the first library or the second library is not being used by a module at a higher layer, the reading unit 13 replaces the first library and reads the second library.

In this manner, in the example embodiment, the first library is automatically replaced with the second library (advanced library), and thus, even when the second library is used, it is possible to eliminate the need to rewrite the source code of a module.

In addition, when the source code of a module is manually edited, a mistake such as miswriting the source code occurs. Therefore, the source code is not desired to be manually edited whenever possible.

There is the possibility that various editing errors will occur such as a case where consistency is lost as a result of rewriting a source code and undoing changes, a case where a batch edit command is executed with a wrong format, and a case where it is forgotten that a file has been copied for a second library and a different file is edited.

However, in the example embodiment, the first library is automatically replaced with the second library, and thus it is possible to eliminate the need to edit a source code.

Furthermore, when the first library is read by a module in which the first library has been replaced with the second library (for example, when a fallback function or the like is used), infinite recursion occurs.

However, in the example embodiment, a configuration can be adopted in which the first library is not replaced with the second library, and thus infinite recursion can be prevented.

### [System Configuration]

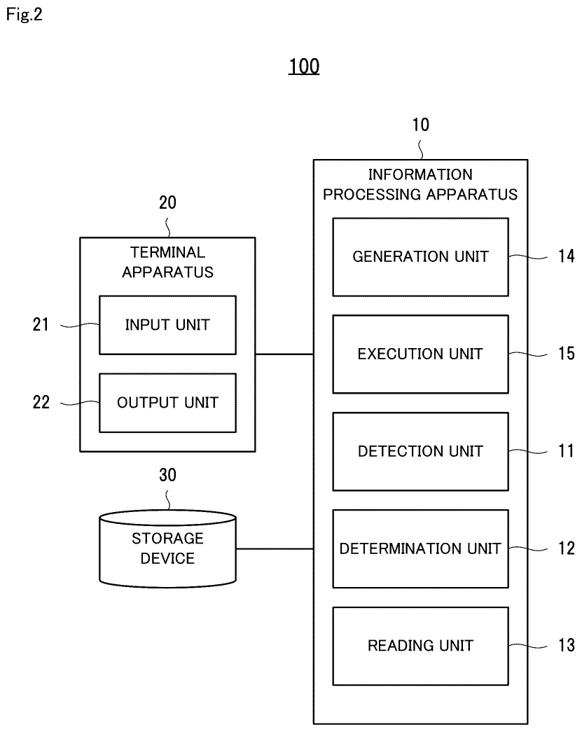

Next, a configuration of the information processing apparatus 10 according to the example embodiment will be described in more detail with reference to FIG. 2. FIG. 2 is a diagram for describing an example of a system that includes the information processing apparatus.

A system 100 shown in FIG. 2 includes the information processing apparatus 10, a terminal apparatus 20, and a storage device 30. In addition, the information processing apparatus 10, the terminal apparatus 20, and the storage device 30 are electrically connected to each other by a network. Note that the system is not limited to the configuration of the system 100 shown in FIG. 2.

The network is an ordinary network constructed using a communication line such as the Internet, a LAN (Local Area Network), a dedicated line, a phone line, an intranet, a mobile communication network, Bluetooth (registered trademark), or WiFi (Wireless Fidelity).

The information processing apparatus 10 is an information processing apparatus such as a CPU (Central Processing Unit), a programmable device such as an FPGA (Field-Programmable Gate Array), a GPU (Graphics Processing Unit), or a circuit in which one or more thereof are mounted, or a server computer.

The terminal apparatus 20 is an information processing apparatus such as a personal computer or a mobile terminal in which one of or both a CPU and an FPGA are implemented. In addition, the terminal apparatus 20 includes an input unit 21 and an output unit 22.

The input unit 21 is a device such as a touch panel, a mouse, or a keyboard. The output unit 22 obtains later-described output information subjected to conversion into a format that can be output, and outputs a generated image, sound, and the like based on the output information. The output unit 22 is an image display device that uses a liquid crystal display, an organic EL (Electro Luminescence) display, a CRT (Cathode Ray Tube), or the like. Furthermore, the image display device may include a sound output device such as a speaker. Note that the output unit 22 may be a print apparatus such as a printer.

The storage device 30 is a database, a server computer, a circuit that includes a memory, or the like. The storage device 30 stores, for example, at least information regarding a user program, a module, and the like. In the example in FIG. 2, the storage device 30 is provided outside the information processing apparatus 10, but may be provided inside the information processing apparatus 10.

Note that FIG. 2 shows the system 100, but the information processing apparatus 10 may be used without constructing the system 100. In that case, a personal computer, a mobile terminal, or the like may be used as the information processing apparatus 10.

The information processing apparatus will be described in detail.

The information processing apparatus 10 includes a generation unit 14, an execution unit 15, the detection unit 11, the determination unit 12, and the reading unit 13.

Before a user program is executed, the generation unit 14 generates an interrupt processing unit, and locates the generated interrupt processing unit on a former stage of the reading unit 13. The interrupt processing unit is used for replacing the first library with the second library. In addition, the interrupt processing unit is constituted by the detection unit 11 and the determination unit 12.

In this manner, the interrupt processing unit is located on a former stage of the reading unit 13, and a module is read based on a processing result of the interrupt processing unit. With such a configuration, it is possible to realize, in all areas of the user program, interrupt processing for replacing the first library with the second library.

The execution unit 15 executes a user program using interpreter software. In a case of python, for example, the user program is executed using software called “python interpreter”.

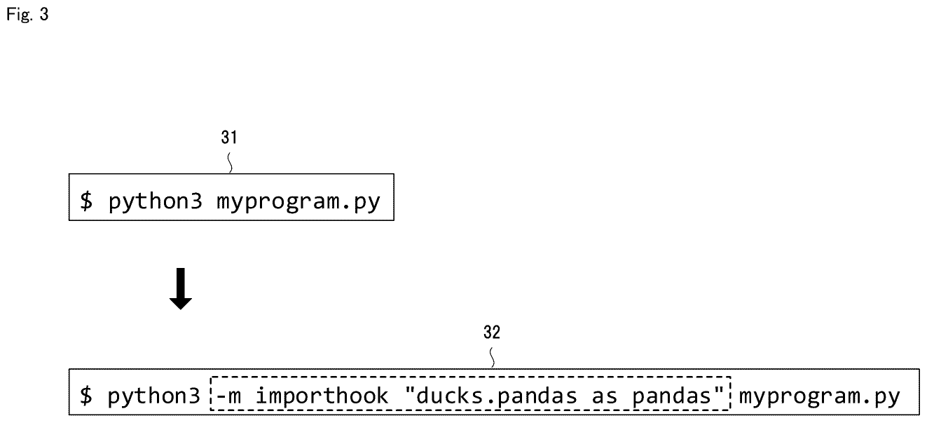

When a user program is executed using python3, for example, a command line to which a monkey patch such as that shown in FIG. 3 has been applied is input. FIG. 3 is a diagram for describing an example of a command line for executing interrupt processing. A command line 31 in FIG. 3 is a command line for executing a user program (myprogram.py) using python3. A code 32 is a command line in which an import hook “-m importhook “ducks.pandas as pandas”” is set in a user program (myprogram.py).

When a code for reading a module is detected, the reading unit 13 reads the module. In a case of python, for example, after an import sentence is detected as a code for reading a module, the module that is to be read and is included in the import sentence is read.

When interrupt processing for replacing the first library with the second library that is compatible with the first library occurs, the detection unit 11 first detects whether or not the code for reading the module includes a code for reading the first library.

Next, when a detection result of the detection unit 11 indicates that the source code of an obtained module does not include a code for reading the first library, the detection unit 11 instructs the reading unit 13 to read the obtained module.

The reading unit 13 then reads the module (module other than the first library and the second library) included in the code for reading the module.

If a detection result of the detection unit 11 indicates that the source code of the obtained module includes a code for reading the first library, the determination unit 12 refers to hierarchy information indicating the parent-child relationship for reading modules, and determines whether or not the first library or the second library is being used by a module at a higher layer than the reading layer of the first library.

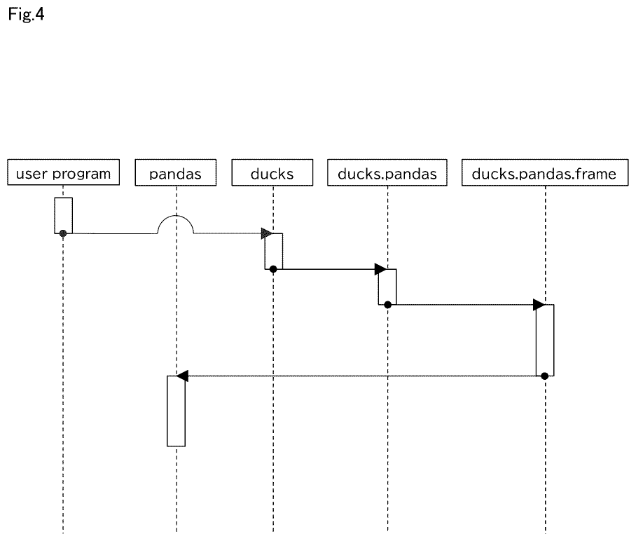

FIG. 4 is a diagram for describing an example of operations of the determination unit. In the example in FIG. 4, when a target module is a user program, a code for reading the first library (pandas) is included. In addition, there is no layer higher than a reading layer of the first library, and thus it is determined that the first library (pandas) is to be replaced with a second library (ducks).

Next, when the target module (ducks.pandas.frame) includes a code for reading the first library (pandas), layers (ducks.pandas->ducks->user program) higher than the reading layer (ducks.pandas.frame) of the first library are traced back. As a result, the target module (ducks.pandas.frame) is a portion of the second library (ducks), and thus it is determined that the first library is not to be replaced with the second library.

Next, the determination unit 12 instructs the reading unit 13 to read the second library based on the determination result. The reading unit 13 then reads the second library.

In addition, when the first library or the second library is being used by a module at a higher layer than the reading layer of the first library, the determination unit 12 determines that the first library is not to be replaced with the second library.

Next, the determination unit 12 instructs the reading unit 13 to read the first library based 20) on the determination result. The reading unit 13 then reads the first library.

### [Apparatus Operations]

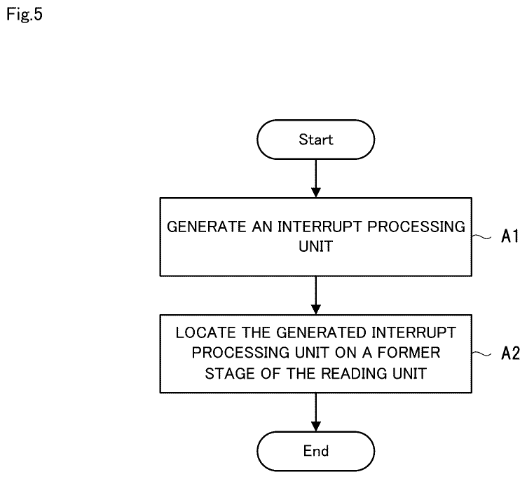

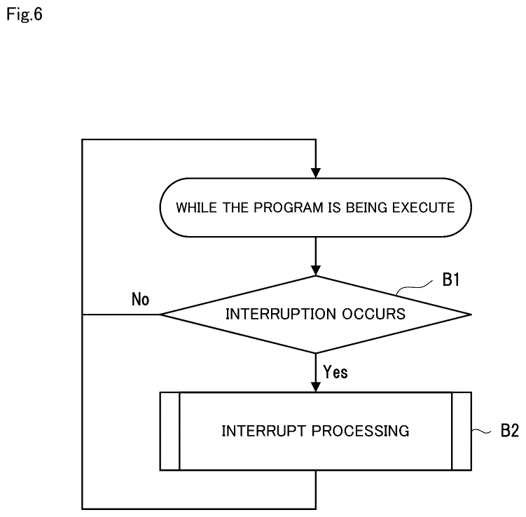

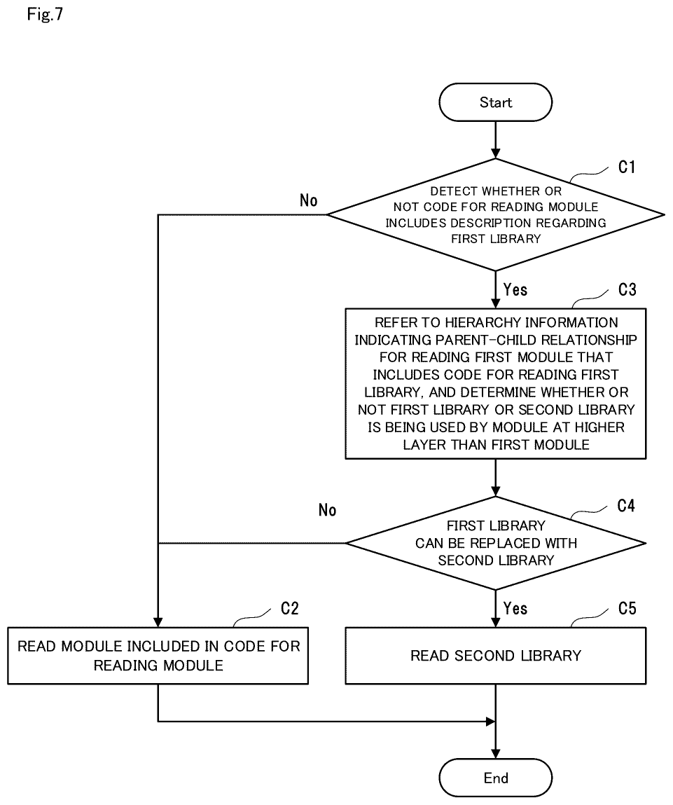

Next, operations of the information processing apparatus according to the example embodiment will be described with reference to FIGS. 5 to 7. FIG. 5 is a diagram for describing an example of operations of generation of an interrupt processing unit. FIG. 6 is a diagram for describing an example of operations of interrupt processing. FIG. 7 is a diagram for describing an example of operations of the interrupt processing unit.

In the following description, drawings are referenced as appropriate. In addition, in an example embodiment, an information processing method is performed by causing the information processing apparatus to operate. Thus, the following description of operations of the information processing apparatus is used as description of the information processing method according to the example embodiment.

### Generation of Interruption Processing Unit

As shown in FIG. 5, first, before the user program is executed, the generation unit 14 generates an interrupt processing unit (the detection unit 11, the determination unit 12, and a replacing unit 13) (step A1).

Next, the generation unit 14 locates the generated interrupt processing unit on a former stage of the reading unit 13 (step A2). Specifically, in step A2, the generation unit 14 causes the reading unit 13 to read a module, based on a processing result of the generated interrupt processing unit.

### Operation of Interruption Processing Unit

In the example in FIG. 6, the execution unit 15 executes a user program. Next, when interruption related to reading of the first library occurs while the program is being executed (step B1: Yes), the interrupt processing unit executes interrupt processing (step B2).

Note that, when interruption related to reading of the first library has not occurred (step B1: No), execution of the program continues.

Next, interrupt processing in step B2 will be described. As shown in FIG. 7, first, when interrupt processing for replacing the first library with the second library compatible with the first library occurs, the detection unit 11 detects whether or not a code for reading a module includes a code for reading the first library (step C1).

Next, if a detection result of the detection unit 11 indicates that the source code of the obtained module does not include a code for reading the first library (step C1: No), the detection unit 11 instructs the reading unit 13 to read the obtained module.

The reading unit 13 then reads the module (module different from the first library and the second library) included in the code for reading the module (step C2).

In addition, if a detection result of the detection unit 11 indicates that the source code of the obtained module includes a code for reading the first library (step C1: Yes), the determination unit 12 executes determination processing (step C3).

Determination processing will be described. In the determination processing in step C3, hierarchy information indicating the parent-child relationship for reading modules is referred to, and it is determined as to whether or not the first library or the second library is being used by a module at a higher layer than the reading layer of the first library.

Next, the determination unit 12 instructs the reading unit 13 to read the second library, based on the determination result in step C3 (the first library can be replaced) (step C4: Yes). The reading unit 13 then reads the second library (step C5).

In addition, when the first library or the second library is being used by a module at a higher layer than the reading layer of the first library, it is determined that the first library is not to be replaced with the second library.

Next, the determination unit 12 instructs the reading unit 13 to read the first library, based on the determination result in step C3 (the first library cannot be replaced) (step C4: No). The reading unit 13 then reads the first library (step C2).

### Effects of Example Embodiment

As described above, according to an example embodiment, the first library is automatically replaced with the second library (advanced library), and thus, even when the second library is used, it is possible to eliminate the need to the rewrite the source code of a module.

In addition, in the example embodiment, the first library is automatically replaced with the second library, and thus it is possible to eliminate the need to edit the source code.

Furthermore, in the example embodiment, a configuration can be adopted in which the first library is not replaced with the second library, and thus infinite recursion can be prevented.

### Modified Example

A modified example will be described. Processing of the determination unit 12 takes time, and thus a large part of related libraries may be read in advance and cached before a program is executed. The related libraries are the first library and the second library.

### [Program]

The program according to the embodiment may be a program that causes a computer to execute steps A1 to A2 shown in FIG. 5, steps B1 to B2 shown in FIG. 6 and steps C1 to C5 shown in FIG. 7. By installing this program in a computer and executing the program, the information processing apparatus and the information processing method according to the example embodiment can be realized. In this case, the processor of the computer performs processing to function as the generation unit 14, the execution unit 15, the detection unit 11, the determination unit 12, and the reading unit 13.

Also, the program according to the embodiment may be executed by a computer system constructed by a plurality of computers. In this case, for example, each computer may function as any of the generation unit 14, the execution unit 15, the detection unit 11, the determination unit 12, and the reading unit 13.

### [Physical Configuration]

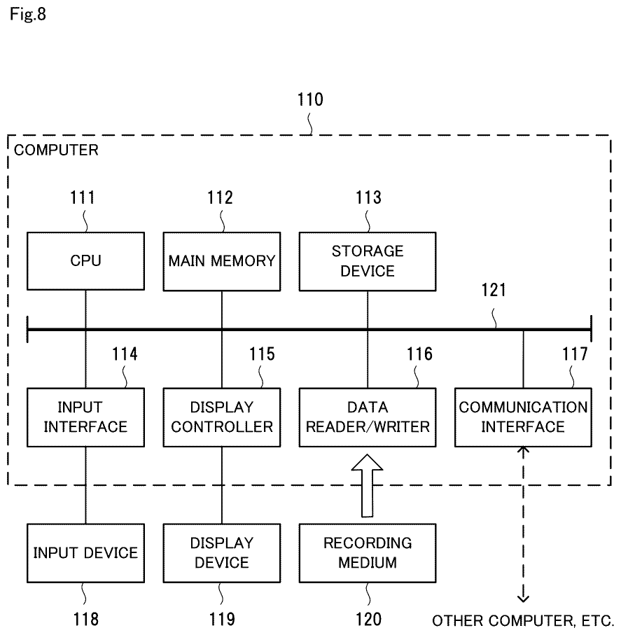

Here, a computer that realizes the information processing apparatus by executing the program according the example embodiment and modified example will be described with reference to FIG. 8. FIG. 8 is a diagram for describing an example of a computer that realizes the information processing apparatus in the example embodiment and modified example.

As shown in FIG. 8, a computer 110 includes a CPU (Central Processing Unit) 111, a main memory 112, a storage device 113, an input interface 114, a display controller 115, a data reader/writer 116, and a communications interface 117. These units are each connected so as to be capable of performing data communications with each other through a bus 121. Note that the computer 110 may include a GPU (Graphics Processing Unit) or an FPGA (Field-Programmable Gate Array) in addition to the CPU 111 or in place of the CPU 111.

The CPU 111 opens the program (code) according to this example embodiment, which has been stored in the storage device 113, in the main memory 112 and performs various operations by executing the program in a predetermined order. The main memory 112 is typically a volatile storage device such as a DRAM (Dynamic Random Access Memory).

Also, the program according to this example embodiment is provided in a state being stored in a computer-readable recording medium 120. Note that the program according to this example embodiment may be distributed on the Internet, which is connected through the communications interface 117. Note that the computer-readable recording medium 120 is a non-volatile recording medium.

Also, other than a hard disk drive, a semiconductor storage device such as a flash memory can be given as a specific example of the storage device 113. The input interface 114 mediates data transmission between the CPU 111 and an input device 118, which may be a keyboard or mouse. The display controller 115 is connected to a display device 119, and controls display on the display device 119.

The data reader/writer 116 mediates data transmission between the CPU 111 and the recording medium 120, and executes reading of a program from the recording medium 120 and writing of processing results in the computer 110 to the recording medium 120. The communications interface 117 mediates data transmission between the CPU 111 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 120.

The information processing apparatus 10 according to the example embodiment can also be achieved using hardware corresponding to the components, instead of a computer in which a program is installed. Furthermore, a part of information processing apparatus 10 may be realized by a program and the remaining part may be realized by hardware. In the example embodiment, the computer is not limited to the computer shown in FIG. 8.

### Supplementary Notes

The following supplementary notes are also disclosed in relation to the above-described example embodiments. Although at least part or all of the above-described example embodiments can be expressed as, but are not limited to, (Supplementary note 1) to (Supplementary note 12) described below.

### (Supplementary Note 1)

An information processing apparatus comprising:
a detection unit that detects whether or not a code for reading a module includes a description regarding a first library when interrupt processing for replacing the first library with a second library compatible with the first library occurs;
a determination unit that, when a code for reading the first library is detected, refers to hierarchy information indicating a parent-child relationship for reading a first module that includes the code for reading the first library, and determines whether or not the first library or the second library is being used by a module at a higher layer than the first module; and
a reading unit that reads the second library in place of the first library if the first library or the second library is not being used by a module at a higher layer.

### (Supplementary Note 2)

The information processing apparatus according to Supplementary note 1,
wherein, if a module at a higher layer includes the first library or the second library, the reading unit reads the first library.

### (Supplementary Note 3)

The information processing apparatus according to Supplementary note 1, further comprising:
generates the detection unit and the determination unit, before a user program is executed.

### (Supplementary Note 4)

The information processing apparatus according to any one of Supplementary notes 1 to 3,
wherein the first library is pandas that is a library of Python.

### (Supplementary Note 5)

An information processing method that is performed by an information processing apparatus, the method comprising:
detecting whether or not a code for reading a module includes a description regarding a first library when interrupt processing for replacing the first library with a second library compatible with the first library occurs;
when a code for reading the first library is detected, referring to hierarchy information indicating a parent-child relationship for reading a first module that includes the code for reading the first library, and determining whether or not the first library or the second library is being used by a module at a higher layer than the first module; and
reading the second library in place of the first library if the first library or the second library is not being used by a module at a higher layer.

### (Supplementary Note 6)

The information processing method according to Supplementary note 5,
wherein, if a module at a higher layer includes the first library or the second library, reading the first library.

### (Supplementary Note 7)

The information processing method according to Supplementary note 5,
generating the detection unit and the determination unit, before a user program is executed.

### (Supplementary Note 8)

The information processing method according to any one of Supplementary notes 5 to 7,
wherein the first library is pandas that is a library of Python.

### (Supplementary Note 9)

A non-transitory computer readable recording medium that includes a program recorded thereon, the program including instructions that causes a computer to carry out the steps of:
detecting whether or not a code for reading a module includes a description regarding a first library when interrupt processing for replacing the first library with a second library compatible with the first library occurs;
when a code for reading the first library is detected, referring to hierarchy information indicating a parent-child relationship for reading a first module that includes the code for reading the first library, and determining whether or not the first library or the second library is being used by a module at a higher layer than the first module; and
reading the second library in place of the first library if the first library or the second library is not being used by a module at a higher layer.

### (Supplementary Note 10)

The non-transitory computer-readable recording medium for recording a program according to Supplementary note 9 further including instructions that cause the computer to: wherein, if a module at a higher layer includes the first library or the second library, reading the first library.

### (Supplementary Note 11)

The non-transitory computer-readable recording medium for recording a program according to Supplementary note 9 further including instructions that cause the computer to:
generating the detection unit and the determination unit, before a user program is executed.

### (Supplementary Note 12)

The non-transitory computer-readable recording medium for recording a program according to any one of Supplementary notes 9 to 11 further including instructions that cause the computer to:
wherein the first library is pandas that is a library of Python.

Although the invention has been described with reference to the example embodiments, the invention is not limited to the example embodiment described above. Various changes can be made to the configuration and details of the invention that can be understood by a person skilled in the art within the scope of the invention.

According to the technology described above, in this manner, in the example embodiment, the first library is automatically replaced with the second library (advanced library), and thus, even when the second library is used, it is possible to eliminate the need to rewrite the source code of a module. In addition, it is useful in a field where the reading the library is required.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An information processing apparatus comprising:
at least one memory storing instructions; and
at least one processor configured to execute the instructions to:
detect whether or not a code for reading a module includes a description regarding a first library when interrupt processing for replacing the first library with a second library compatible with the first library occurs;
when a code for reading the first library is detected, refer to hierarchy information indicating a parent-child relationship for reading a first module that includes the code for reading the first library, and determine whether or not the first library or the second library is being used by a module at a higher layer than the first module; and
read the second library in place of the first library if the first library or the second library is not being used by a module at a higher layer.

2. The information processing apparatus according to claim 1,
wherein the one or more processors further:
if a module at a higher layer includes the first library or the second library, read the first library.

3. The information processing apparatus according to claim 1,
wherein the one or more processors further:
generate a unit that executes the detection and the determination and locate the unit on a former stage of a unit for reading, before a user program is executed.

4. The information processing apparatus according to claim 1,
wherein the first library is pandas that is a library of Python.

5. An information processing method that is performed by an information processing apparatus, the method comprising:
detecting whether or not a code for reading a module includes a description regarding a first library when interrupt processing for replacing the first library with a second library compatible with the first library occurs;
when a code for reading the first library is detected, referring to hierarchy information indicating a parent-child relationship for reading a first module that includes the code for reading the first library, and determining whether or not the first library or the second library is being used by a module at a higher layer than the first module; and
reading the second library in place of the first library if the first library or the second library is not being used by a module at a higher layer.

6. A non-transitory computer readable recording medium that includes a program recorded thereon, the program including instructions that causes a computer to carry out the steps of:
detecting whether or not a code for reading a module includes a description regarding a first library when interrupt processing for replacing the first library with a second library compatible with the first library occurs;
when a code for reading the first library is detected, referring to hierarchy information indicating a parent-child relationship for reading a first module that includes the code for reading the first library, and determining whether or not the first library or the second library is being used by a module at a higher layer than the first module; and
reading the second library in place of the first library if the first library or the second library is not being used by a module at a higher layer.
